(19) United States
(12) Patent Application Publication
(10) Pub. No.: US 2003/0113157 A1
(43) Pub. Date: Jun. 19, 2003

(54) ARRANGEMENT FOR MOUNTING A FIRST COMPONENT IN RELATION TO A SECOND COMPONENT

(75) Inventors: Jan-Olof BODIN, Alingsas (SE); Goran LEVIN, Hisings-Karra (SE)

(73) Assignee: Volvo Lastvagnar AB, Goteborg, S-405 08 (SE)

(21) Appl. No.: 10/248,967

(22) Filed: Mar. 6, 2003

Related U.S. Application Data
(63) Continuation of application No. PCT/SE01/01873, filed on Sep. 4, 2001, now abandoned.

(30) Foreign Application Priority Data
Sep. 6, 2000 (SE) 0003134-4

(51) Int. Cl. F16D 1/12

(52) U.S. Cl. 403/122

(57) ABSTRACT

### Abstract of Disclosure

Method and arrangement for mounting a first component (1; 1') in relation to a second component (2; 2'). The second component (2; 2') includes a through hole (3; 3' 3''), wherein the first component, (1; 1') that includes an end section (4) which is provided with threads (5) and is adapted to be guided into and inserted through the hole (3; 3' 3'') in the second component (2; 2') and is adapted to be locked by means of a locking nut (6). A first component (1; 1') includes an essentially cylindrical part (7; 19) having a slightly larger outside diameter than the inside diameter of the hole (3; 3' 3'') and being adapted for forced fit against the inside surface of the hole (3; 3' 3''). The invention also relates to a method for mounting the arrangement.

### Cross Reference to Related Applications

This application is a continuation patent application of International Application No. PCT/SE01/01873 filed 4 September 2001 which was published in English pursuant to Article 21(2) of the Patent Cooperation Treaty, and which claims priority to Swedish Application No. 0003134-4, filed 6 September 2000. Both applications are expressly incorporated herein by reference in their entireties.

### Background of Invention

TECHNICAL FIELD: The present invention relates to an arrangement for mounting a first component in relation to a second component, and the second component includes a through hole. The first component includes an end section that is provided with threads and is adapted to be guided into, and inserted through, the hole in the second component, and is also adapted to be locked by means of a locking nut. The invention also relates to the associated method for mounting the first component in the second component.

BACKGROUND OF THE INVENTION: In various contexts, there is a demand for mounting devices for mounting and connecting different components in relation to each other. For example, in the field of vehicles, there is a demand for arrangements and methods for mounting ball joints, which are exemplarily utilized when mounting link rods, tie rods, stabilizers and similar components which form part of the wheel suspension of the vehicle.

As an example, ball joints can be utilized in a front wheel suspension of a passenger car or a commercial vehicle; more precisely, between a steering arm on a wheel axle and a suspension arm or a tie rod. In these cases, the ball joint is mounted by means of a ball joint bolt, one end section of which is essentially ball-shaped and rests in a ball joint housing that is connected with the suspension arm or a tie rod. In this case, the opposite end section of the ball joint bolt is provided with threads and is adapted to be mounted in a through hole in the steering arm. In this manner, advantages are provided in so far as the ball joint provides an opportunity to compensate for irregularities in the roadway that would have otherwise caused stronger jolts to the carried vehicle.

Traditionally, ball joint bolts, at a threaded end section thereof, have been inserted through a corresponding through hole from one side of a receiving component, for example, a steering arm, and were typically anchored on the opposite side of the component by means of a castle nut. Normally, for a correct mounting, a split pin has also been utilized which is inserted through a through hole in the bolt after tightening the castle nut. In this manner, a safety arrangement has been provided by means of which the castle nut is prevented from being gradually and unintentionally loosened or unscrewed from the bolt, allowing the bolt to fall out of its mounting.

One drawback regarding previously known method relates to the complicated nature of the mounting method where the castle nut first must be tightened by means of a suitable tightening force. Then, the split pin must be mounted by being inserted through the bolt. During this process, it is often difficult finding the hole in the nut which is intended for the split pin. Often, this can result in repeated tightenings of the nut, which in turn results in losses of time and cost. Moreover, it is perceived as difficult and time-consuming to have to mount the split pin.

Thus, it can be stated that existing methods for mounting ball joint bolts in vehicles result in problems regarding accessibility, time consumption and cost.

An additional drawback regarding the prior art relates to the fact that the castle nut normally is tightened to a predetermined tightening moment. After that, additional tightening is necessary so that the hole of the split pin comes into right position in order for the split pin to be able to be mounted. This in turn results in a risk that the tightening will result in a locking moment that cannot be predetermined in an exact manner.

A joint for mounting a bolt in a through hole of another component is shown in US 5,538,356. Therein, the bolt has a cone-shaped bolt section that inclines inwards in an axial direction and is intended for cooperation with an internally cone-shaped sleeve element. This sleeve element is in turn constructed by a number of segments which extend around a certain sector of the conical bolt section. The purpose of this arrangement is to counteract rotary movements of the bolt in the hole.

The bolt is tightened by means of a nut, which in turn includes a radially protruding flange which co-operates with an upper part of the sleeve element. Thus, when the nut is tightened, the sleeve element will be inserted into the hole, between the inside of the hole and the conical bolt section. After tightening, the conical bolt section will occupy the space between the conical section of the bolt and the inside surface of the hole.

One drawback related to arrangements configured according to US 5,538,356 is that it includes a comparatively large number of parts and, has a comparatively complicated structure.

### Summary of Invention

One objective of the present invention is to provide an improved arrangement for connecting a first component and a second component, particularly in which a first component takes the form of a ball joint bolt and a second component is a part of the wheel suspension system in a vehicle and by means of which the above-mentioned problems with known solutions are solved in an efficient manner. This is achieved by means of an arrangement of the type that has been mentioned and which is characterized by the fact that the first component includes an essentially cylindrical part having a slightly larger outside diameter than the inside diameter of the hole and is adapted for forced fit against the inside surface of the hole.

This objective is also achieved by way of a method characterized in that it includes fitting an essentially cylindrical part of the first component into the hole during forced-fit against the inside surface of the hole during the locking.

By means of the present invention, several advantages are achieved. First, it can be stated that a substantial amount of time can be saved in connection with the mounting and in addition, there is no need to use expensive special purpose machineries.

By means of the cylindrical part, a forced fit is provided in the hole, which results in a rotary lock and high strength in the joint. Moreover, improved safety is provided by means of the forced fit, which results in the ball joint being capable of remaining in place, even if the nut should come loose.

Furthermore, the invention provides an exactly defined locking moment after tightening the locking nut. This is particularly so when the invention is utilized with a locking nut having a conical thread. By means of this locking nut, an advantage is also provided in so far as no split pin needs to be used.

### Brief Description of Drawings

The invention will be explained in further detail below, with reference to a preferred embodiment exemplarily illustrated in the included drawings, of which:

Fig. 1 is an exploded view of an arrangement configured according to the present invention in a disassembled condition;

Fig. 2 is an elevational view, shown in partial-cutaway and partial cross-section, showing the arrangement of Fig. 1 in a first condition in the course of assembling the arrangement;

Fig. 3 is an elevational view, shown in partial-cutaway and partial cross-section, showing the arrangement of Fig. 1 in a second condition occurring after assembly of the arrangement;

Fig. 4 is an elevational view, shown in partial-cutaway and partial cross-section, showing a second embodiment of the arrangement in a first condition during assembly;

Fig. 5 is an elevational view, shown in partial-cutaway and partial cross-section, showing the arrangement of Fig. 4 in a second condition occurring after assembly of the arrangement;

Fig. 6 is an elevational view, shown in partial-cutaway and partial cross-section, showing a third embodiment of the arrangement in a first condition during assembly;

Fig. 7 is an elevational view, shown in partial-cutaway and partial cross-section, showing the arrangement of Fig. 6 in a second condition occurring after assembly of the arrangement.

### Detailed Description

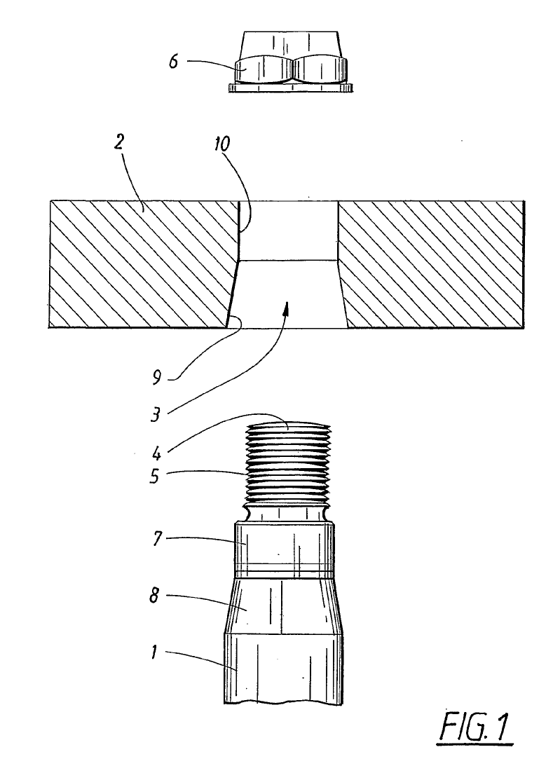

Fig. 1 shows a side elevational view of an arrangement according to the present invention and shown in an exploded view. According to a preferred embodiment, the invention is intended for utilization in connection with vehicles and constitutes an arrangement for mounting a first component in the form of a ball joint bolt 1 in relation to a second component exemplarily taking the form of a vehicle component 2, for example, a steering arm, which in turn is connected with one of the vehicle's wheels.

The invention is, however, not limited for utilization merely in connection with vehicles, but may in principle be utilized for all types of bolt joints where there exists a desire to prevent the bolt from rotating. The invention, however, is particularly suitable for utilization in connection with ball joints.

According to Fig. 1, which shows the invention according to a first embodiment in a disassembled condition, the ball joint bolt 1 is intended to be mounted in a through hole 3 in the vehicle component 2. One of the end sections of the ball joint bolt 1 is provided with a first section in the form of an insertion part 4, while an opposite (or other) end section is provided with a ball, though not apparent Fig. 1, that is adapted and intended to be mounted in a ball joint housing. The ball joint housing is in turn connected with an additional vehicle component, exemplarily in the form of a suspension arm or a tie rod as described hereinabove.

Preferably, the insertion part 4 is formed with a considerably smaller diameter than the inside diameter of the through hole 3, and thus defines a play against the opening of the hole 3. The insertion part 4 is also provided with male threads 5 which are intended to co-operate with a nut 6, more precisely female threads of the nut 6.

Furthermore, the ball joint bolt 1 is provided with a second section in the form of a cylindrical part 7, which is intended to co-operate with the through hole 3. More precisely, it is a basic principle of the invention that the cylindrical part 7 is adapted for forced fit in the through hole 3 and to this end it is provided with an outside diameter which is slightly larger than the inside diameter of the hole 3. In a typical application, where the through hole 3 has an inside diameter which can be of the order of 20-40 millimeters, the outside diameter of the cylindrical part 7 is preferably one, to a few, hundredths of a millimeter larger than the inside diameter of the hole 3. According to the detailed description below, this results in the cylindrical part 7 after mounting the entire arrangement functioning as a rotary lock with respect to the mounting of the ball joint bolt 1 in the hole 3.

The invention is, however, not limited to any specific dimensions, regarding the ball joint bolt 1, the hole 3 or the selection of diameter for the cylindrical part 7 and the hole 3. Thus, various solutions are possible within the scope of the invention as long as the cylindrical part 7 is formed as a rotary lock in the hole 3.

Furthermore, the ball joint bolt 1 preferably includes a third section in the form of a conical part 8, which is intended to bear against and co-operate with a corresponding conical section 9 which is formed in the through hole 3. More precisely, in the part of the hole 3 which is closest to the ball joint 1. In this case, the conical part 8 constitutes a load-distributing element which absorbs force which acts between the ball joint bolt 1 and the vehicle component 2, after mounting.

Apart from the conical section 9 in the hole 3, this is, according to what is apparent from Fig. 1, provided with an essentially cylindrical inside section 10, the length of which at least corresponds to the length of the above-mentioned cylindrical part 7 of the ball joint bolt 1. As mentioned above, the cylindrical inside section 10 is provided with a diameter which is slightly smaller than the corresponding outside diameter of the cylindrical part 7 of the ball joint bolt 1.

According to what will be apparent below, the invention is not limited to the fact the ball joint bolt and the hole include conical sections, but these details may in principle be omitted in some applications, for example, where there are fewer demands regarding load-absorption and load-distributing characteristics.

Fig. 2 shows a side elevational view that corresponds to the embodiment configured according to Fig. 1, but which shows the invention in a condition during mounting. From Fig. 2, it is also indicated by means of broken lines that the ball joint bolt 1 ends with a ball 11 which is provided in a ball joint housing 12, and which in turn is connected with an additional vehicle component, for example in the form of a suspension arm 12 which forms part of the wheel suspension of the vehicle in question.

Fig. 2 shows the invention in a position where the ball joint bolt 1 recently has been inserted into the through hole 3, and in which the insertion part 4 protrudes a small distance through the hole 3. In this condition, the above-mentioned locking nut 6 is suitably provided. Preferably, in connection with the invention, a type of nut is utilized which is provided with cone-shaped female threads. Locking nuts of this type are generally known, and are based on the fact that the conical threads only allow tightening of the nut for a predetermined distance. After that, the locking nut 6 cannot be screwed any further. Preferably, the length of the protruding section 4 of the nut together with the shape of the corresponding conical threads in the locking nut 6 is adjusted so that the locking nut 6 after complete tightening defines a predetermined locking moment which acts against the vehicle component in question.

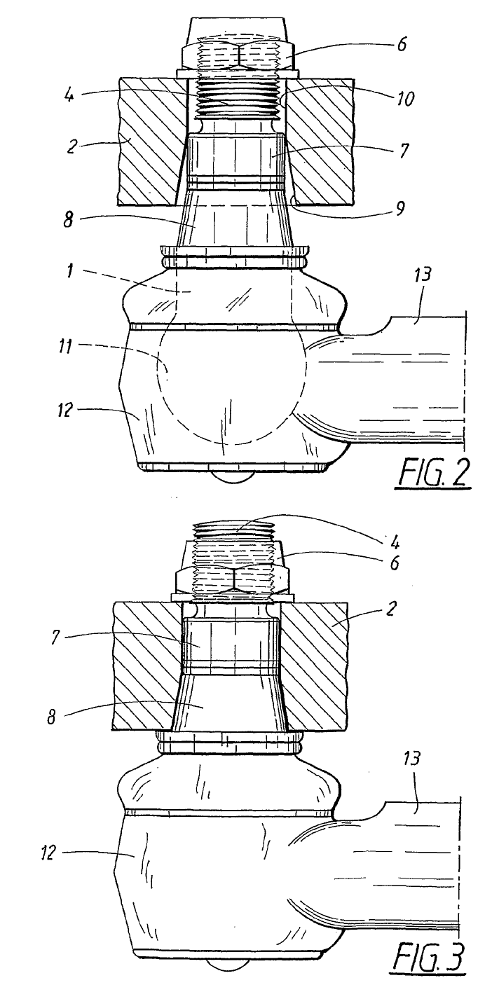

Thus, with reference to Fig. 2, it is apparent that the locking nut 6 is tightened while the cylindrical part 7 of the ball joint bolt 1 engages with the inside wall of the hole 3. After tightening, the arrangement assumes a mounted condition which is apparent from Fig. 3. In this condition, the entire cylindrical part 7 has been fitted into the cylindrical part 10 in the hole 3 by means of forced fit, so that a rotary locking of the ball joint bolt 1 is provided. After tightening, the locking nut 6 provides a predetermined tightening moment together with the threaded section 5 on the ball joint bolt 1. In addition, the conical part 8 of the bolt 1 will co-operate with the corresponding conical section 9 in the hole 3 in a load-distributing manner.

Thus, after mounting the entire arrangement, it provides a rotary lock of the ball joint bolt 1 in the hole 3. In addition, by means of the co-operation of the conical sections 8, 9, a load-distributing effect is provided as regards the mounting of the ball joint bolt 1. Furthermore, a simple and efficient mounting is provided without having to use any split pin.

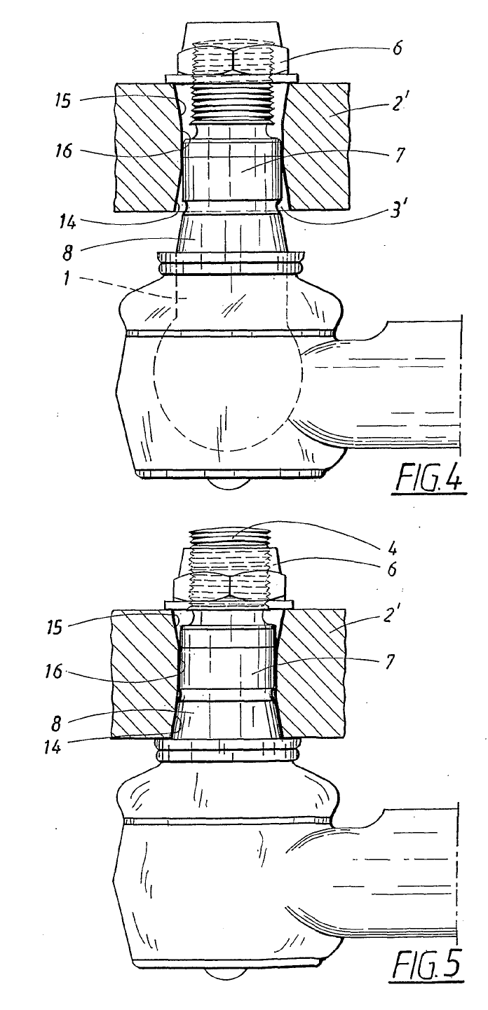

Fig. 4 shows a second embodiment of the invention, which illustrates the function of the invention during mounting of the ball joint bolt 1, which in principle is of the same type as the ball joint bolt which is shown with reference to Figs. 1-3. Furthermore, the ball joint bolt 1 is intended to be mounted in a vehicle component 2', for example, a steering arm, which includes a through hole 3'. This hole 3' is different from what has been explained above in so far as it is provided with two conical sections, more precisely a first conical section 14 which is directed towards the ball joint bolt 1 and a second conical section 15 which is directed away from the ball joint bolt in the direction of the locking nut 6. Furthermore, the hole 3' is provided with a cylindrical section 16 between the conical sections 14, 15. In this case, the length of the cylindrical section 16 essentially corresponds to the length of the cylindrical part 7 of the ball joint bolt 1.

The advantage as regards the arrangement according to Fig. 3 is that the vehicle component 2' provides mounting of the ball joint bolt 1 from any optional side. The benefit is that one single variant of the relevant vehicle component can in this case be utilized without having to consider how this is directed in relation to the ball joint bolt 1.

Fig. 5 shows the arrangement according to the second embodiment in a mounted condition. From the drawing, it is apparent that after mounting wherein the locking nut 6 has been tightened until locking takes place, which defines a predetermined locking moment the cylindrical part 7 of the bolt will be positioned, via forced fit, right in front of the cylindrical section 16 in the hole 3'. Furthermore, the conical part 8 of the bolt will bear against one of the conical sections 14 of the hole 3'. However, by means of the fact that the hole 3' is provided with two conical sections 14, 15, the ball joint bolt 1 according to the second embodiment might just as well have been inserted from the opposite side of the hole 3'.

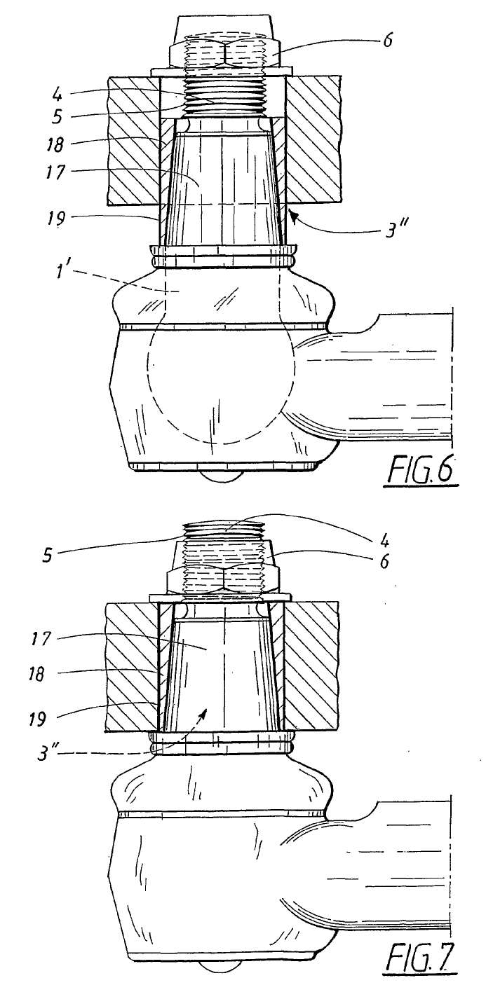

Fig. 6 shows a third embodiment of the invention. According to this embodiment, a ball joint bolt 1' is utilized which apart from an insertion part 4 with threads 5 also includes a conical part 17. This conical part 17 is shaped in order to support a separate sleeve-like component 18, i.e. the conical part 17 on the ball joint bolt co-operates with a corresponding conical inside surface on the sleeve 18. Furthermore, the outside casing surface 19 of the sleeve 18 defines a cylindrical part which by analogy with what has been explained above is provided with an outside diameter which slightly exceeds the inside diameter of a corresponding through hole 3'' in the vehicle component 2 in question. Also in this instance, the difference in diameter suitably amounts to one or a few hundredths of a mm.

Suitably, in this third embodiment, no conical section in the hole 3'' is utilized. Instead, the entire inside diameter in the hole 3'' is essentially the same along the entire hole 3''. During mounting, the sleeve 18 is first put in place over the conical part of the ball joint bolt 1', whereupon the sleeve 18 and the bolt 1' are pressed into the hole 3''. Furthermore, the different components are dimensioned so that the threaded section 5 protrudes a distance through the hole 3'' in order to co-operate with the conical threads in the locking nut 6. Next, the locking nut 6 is tightened, wherein a fixed locking moment is provided by analogy with what has been described above. During the tightening, the sleeve 18, and in that way the bolt 1'as well, is locked against the inside wall of the hole 3'' by means of forced fit. The condition in which the arrangement is mounted is apparent from Fig. 7.

The invention is not limited to the embodiments which are described above and shown in the drawings, but may be varied within the scope of the appended patent claims. For example, the invention can be used for various types of vehicles, for example commercial vehicles and passenger cars , and in those cases suitable for mounting of ball joints in wheel suspensions. In principle, the invention also can be utilized for other applications, then what than vehicles where there is a demand for joints where there exists a problem with preventing a bolt from rotating.

Even if it is not necessary, the joint according to the invention can be supplemented with a split pin through a hole in the respective bolt. In this case, this results in an increased degree of safety.

Claims

1. An arrangement for mounting a first component in relation to a second component comprising:
a second component comprising a through hole
a first component comprising an end section which is provided with threads and is adapted to be guided into and inserted through said hole in said second component and is adapted to be locked by means of a locking nut;
said first component comprises an essentially cylindrical part having a slightly larger outside diameter than the inside diameter of said hole and being adapted for forced fit against the inside surface of said hole.

2. The arrangement as recited in claim 1, wherein the threads on said end section are adapted for co-operation with a locking nut which is provided with inner, conical threads and dimensioned for a predetermined locking force after mounting.

3. The arrangement as recited in claim 1, wherein said first component is provided with a conical section which is adapted for co-operating in a load-distributing manner with a correspondingly formed conical section in the hole.

4. The arrangement as recited in claim 1, wherein said cylindrical part is constituted by a casing surface of a sleeve-shaped element which is adapted to be arranged around said first component.

5. The arrangement as recited in claim 1, wherein said first component is constituted by a ball joint bolt and said second component is constituted by a movable arm in a wheel suspension of a vehicle.

6. The arrangement as recited in claim 1, wherein said ball joint bolt is connected with a suspension arm or a tie rod in said vehicle.

7. A method for mounting a first component in relation to a second component, wherein said second component comprises a through hole and wherein said first component comprises an end section which is provided with threads, the method comprising:
guiding and inserting said end section into and through said hole in said second component;
locking said first component by means of a locking nut:
fitting an essentially cylindrical part of said first component into said hole during forced fit against the inside surface of said hole during said locking.

8. The method according to claim 7, wherein said locking takes place by means of co-operation with inner, conical threads on said locking nut, by means of which a predetermined locking force is provided after mounting.
